(19) United States
(12) Patent Application Publication
(10) Pub. No.: US 2003/0134219 A1
(43) Pub. Date: Jul. 17, 2003

(54) Toner composition and fixing method

(76) Inventors: Serge Tavernier, Lint (BE); Dirk Costrop, Duffel (BE); Werner Op De Beeck, Putte (BE); Kurt Mampaey, Rumst (BE)

Correspondence Address: LARSON & TAYLOR, PLC, 1199 NORTH FAIRFAX STREET, SUITE 900, ALEXANDRIA, VA, 22314, US

(21) Appl. No.: 10/203,373

(22) PCT Filed: Feb. 4, 2001
(86) PCT No.: PCT/EP01/01961

(51) Int. Cl. G03G 9/087

(52) U.S. Cl. 430/109.4; 430/111.4; 430/124

(57) ABSTRACT

A toner composition of which the toner particles are electrostatically or magnetically attractable and suitable for use in the satin-look development and fixing of electrostatic charge images or magnetic patterns and wherein the composition of said powder particles comprises a linear non gel containing and a non-linear gel containing polyester, with specific melt characteristics. A method of using such toner particles in specific fixing devices enabling fixing of colour images on different substrates, on two sides within one single pass.

### FIELD OF THE INVENTION

The present invention relates to a toner composition suited for development of electrostatic charge images, magnetic patterns or DEP (Direct Electrostatic Printing).

### BACKGROUND OF THE INVENTION

It is well known in the art of electrographic reproduction to form an electrostatic latent image corresponding to either the original to be copied, or corresponding to digitized data describing an electronically available image. In electrophotography for instance, an electrostatic latent image is formed by the steps of uniformly charging a photoconductive member and image-wise discharging it by an image-wise modulated photo-exposure. In electrography an electrostatic latent image is formed by image-wise depositing electrically charged particles, e.g. from electron beam or ionized gas (plasma) onto a dielectric substrate. In magnetography a latent magnetic image is formed in a magnetizable substrate by a pattern-wise modulated magnetic field.

Regardless of the specific graphic process used, the resulting latent images are developed, i.e. converted into visible images by selectively depositing thereon light absorbing particles, called toner particles, which may be triboelectrically charged or magnetized dependent on the graphic process used.

In toner development of latent electrostatic images two techniques have been applied: “dry” powder and “liquid” dispersion development of which dry powder development is nowadays most frequently used. In dry development the application of dry toner particles to the latent image-bearing substrate can be carried out by different methods known as “cascade”, “magnetic brush”, “powder cloud”, “impression” or “transfer” development also known as “touchdown” development described e.g. by Thomas L. Thourson in IEEE Transactions on Electronic Devices, Vol. ED-19, No.4, April 1972, pp.495-511. Dry-development toners essentially comprise a thermoplastic binder consisting of a thermoplastic resin or mixture of resins including a colorant, e.g. carbon black or finely dispersed dye pigments. The triboelectrically chargeability is defined by said substances and may be modified with a charge controlling agent.

The non-permanent visible developed image of electrostatically or magnetically attracted toner particles is transferred, optionally via one or more intermediate image carrying members, to a substrate where it may be permanently fixed or fused. Usually fixing proceeds by causing or forcing the toner mass to penetrate into the surface irregularities of the substrate, e.g. paper, using pressure and/or heat.

In the fusing processes based on heat, two major types should be considered, the “non-contact” fusing process and the “contact” fusing process. In the non-contact fusing process there is no direct contact of the toner image with a solid heating body. Examples thereof are: an oven heating process in which heat is applied to the toner image by hot air over a wide portion of the support sheet; and a radiant heating process in which heat is applied to the toner images by infrared and/or visible light generated with e.g. an infrared lamp or flash lamp. An advantage of non-contact fusing is that a non-fixed toner image on the substrate is not subjected to a direct contact with a heated body and consequently non-contact fusing is inherently less sensitive to mechanical distortions. Non-contact fusing however has the major disadvantage that due to a malfunction, such as e.g. substrate jam, the substrate may be exposed to excessive heat in the fusing zone for an elongated period causing a fire hazard. This applies particularly to cut sheet-fed engines. Special, costly measures have to be taken to avoid this.

In a contact fusing process, the non-fixed toner images on the substrate are contacted directly with a heated body, i.e. a so-called fusing member, such as fusing roller or a fusing belt. Usually a substrate carrying non-fixed toner images is conveyed through a nip formed by establishing pressure contact between said fusing member and a backing member, such as a roller. Particularly in the case of colour images the fusing degree of the toner should be very good, thus implying the use of resins exhibiting low melt viscosity and low elasticity at the fusing temperature. Such melt behaviour however induces a high sensitivity towards hot offset, i.e. retention of fused toner on the fusing member. A common procedure to avoid this defect is to apply a large amount of release agent such as silicone oil to the fusing member. Although this release agent impedes the hot-offset, it has a negative effect on the image quality because the toner images become too glossy and it may also have adverse effects on finishing processes such as e.g. lamination. This glossy and even greasy look occurs particularly in those parts of the image where a larger amount of toner is deposited, shielding the substrate and impeding some adsorption and drain of release agent. Such conditions are frequently met in colour images, especially in the overlays. When the amount of deposited toner is large additional defects can arise, such as “silicone sweat-out”, giving rise to large stains of release agent on the image. When double sided prints, i.e. so-called duplex prints are generated in two passes, the cited defects are enhanced, as the colour images pass the fusing system twice, resulting in a further increase in the amount of release agent on the images. An additional image degradation is found as a consequence of the fact that one side of the duplex print is at least to some extent exposed twice to heat and pressure in the fusing zone, resulting in gloss differences between back and front of the print. All defects cited and related to the use of release agent substantially reduce the image quality of toner based colour images. Especially when high quality images are wanted, these look and feel defects are extremely important.

Besides the unequal gloss in the high density portions of the images, regardless of the fixing process, one also has to be aware of the problem of unequal gloss between low density portions and high density portions of the images. In the low density portions of the printed images, the toner particles are deposited at low coverage and do not form a closed or solid deposit of black or coloured material. On the other hand, in the high density portions toner particles are piled on each other and co-fused to form a dosed toner-crust which optically has a quite different look to the separately fixed toner particles in the low density portions. Separately deposited and fixed toner particles or small clusters thereof give rise to a light-straying effect. In particular by inspecting the print with light directed thereto at small grazing angle, the low density portions show a matt (dull) appearance. On the other hand, in the high density portions, containing smooth coherently co-fused toner particles, light is reflected by the glossy surface of the toner crust. Reflectivity of the toner is closely related to the kind of binder used, which usually is a relatively hard thermoplastic transparent resin or mixture of resins.

It has been put forward in the prior art that the amount of release agent can be reduced by a specific design of the melt behaviour of the toner particles. The general procedure is to increase the elastic behaviour of the toner. The drawback arising from the viscosity increase associated therewith can be partially dealt with by an increase in fixing temperature while giving in on the fixing quality. Although in the case of black and white images this has been realised to an appreciable degree, this solution is not applicable to the reproduction of colour images. Contrary to black and white images where only a single layer of toner can be present, in case of multi-colour images higher toner piles can also be present. In order to fuse such multi-colour images a low viscosity is required. The fixing degree of the print is also important to avoid image crack if the substrate carrying the printed image is folded. This also implies a low melt viscosity.

The prior art describes trials to design a resin binder matrix for reproducing colour images with increased (moderate) elasticity while limiting the increase in melt viscosity. Different approaches have been put forward. U.S. Pat. No. 5,346,792 describes a resin wherein specific more uncommon soft monomers are incorporated. Another approach puts forwards a very specific design of the molecular weight distribution of the resin, such as in European patent application EP 0774695 describing a resin with a very broad specific molecular weight distribution. Some approaches are based on the blending of two or more polyester resins. For instance European patent application EP 0495475 discloses a blend of two linear polyesters with very specific softening properties, both tuned with respect to each other. The design of a very specific softening behaviour implies a very specific design of molecular weight distribution. In European patent application EP 0495476 there is described a blend of a linear with a non-linear polyester. In order to realise good results the non-linear polyester has to have a very specific composition containing at least 50% of the total acid content in the form of an aliphatic acid. The latter patent is a combination of a very specific molecular weight design and specific composition. Although increasing the amount of low molecular weight resin in the blend may be beneficial to some extent to obtain a higher gloss and a better adhesion, hot offset and lack of resistance to filming and mechanical stress still occurs.

From the description above it is to be concluded that all solutions offered involve less obvious, and costly materials to give some improvement with regard to the fixing and image quality upon fixing of colour images. At the same time there is no specific description in the prior art directed to solving image defects induced by the presence of release agent. It is therefore concluded that there is still need for improvement not only on specific colour toner design but also on the use of such a specific colour toner in a specific fixing process, in order to get high quality colour prints showing no image defects induced by said fixing process, and which offers satin-look colour prints, without gloss unevenness and/or patch-like image defects resulting from fuser rollers and/or release agent.

### SUMMARY OF THE INVENTION

It is an object of the present invention to overcome one or more of the aforesaid disadvantages.

It is a preferred object of the present invention to provide a dry toner wherein the composition of the toner particles is such that the fixed toner image independent of its optical density has the same or almost the same reflection properties.

It is more particularly a preferred object of the present invention to provide a dry toner that after fixing offers a satin-look to the fixed toner image without use of special covering layers for controlling reflection properties.

It is more particularly a preferred object of the present invention to provide such dry toner suited for being fixed to a substrate by contact fusing by moderate heating, allowing double sided fixing in one single pass on different types of substrates at appreciable speed.

It is more particularly a preferred object of the present invention to provide such toner suited for being fixed to a substrate by contact fusing using small amount of external release agent, so as to avoid image quality degradation of said image by said release agent.

Other preferred objects and advantages of the present invention will appear from the further description.

In accordance with the present invention there is provided a toner composition comprising a colorant and a binder resin, said binder resin comprising a linear polyester-based polymer (a) and a non-linear polyester-based polymer (b), said linear polyester-based polymer (a) being characterised by a gel content gₐ of less than 3% by weight, and a melt viscosity ηₐ, (as measured at 120° C.) of between 50 and 1000 Pa s, and said non-linear polyester-based polymer (b) being characterised by a gel content g_{b} of between 3 and 30% by weight, a melt viscosity η_{b} (as measured at 120° C.) of between 100 and 1000 Pa s and an elasticity (tg δ_{b})⁻¹ (as measured at 120° C.) of at least 0.25, wherein for said polymers (a) and (b)

(tg δₐ)⁻¹<2/3(tg δ_{b})⁻¹

and the amount of polymer (a) versus polymer (b) is between 1:4 and 4:1 by weight, most preferably between 1:3 and 3:1.

In accordance with the present invention there is also provided method for fixing unfixed toner images on a recording medium comprising:

feeding at least one recording medium carrying unfixed toner images on at least one surface to a fusing station, said unfixed toner images being composed of toner particles according to the present invention; and

fixing said unfixed toner images on said recording medium by passing said recording medium through a contact zone in said fusing station, formed by pressing a heated upper roller against a heated lower roller in said fusing station.

Further advantages and embodiments of the present invention will become apparent from the following description.

It has been found surprisingly, that it is possible to design a toner composition using simple, commonly available resin materials showing appreciable latitude with respect to the melt behaviour specification and composition, said toner composition allowing the creation of high quality colour prints in terms of image gloss, fixing degree and gloss evenness. It has moreover been found that this particular toner composition is very suited for fixing colour images at a high fusing speed e.g. 10 cm/sec. It has moreover been found that this particular toner composition allows for the use of lower amounts of release agents, e.g. smaller than 50 mg/A4 even down to 30 mg/A4, in the hot roller fixing process (an A4 page having dimensions of 21 cm by 29.7 cm). It has been found that using this toner composition it is possible to design a fixing process allowing for a single pass duplex fusing at the above mentioned speed and with said low release agent level, allowing the realisation of high quality colour images. The different aspects of the invention will be described in more detail hereinafter.

The specific toner composition is characterised by the fact that the resin binder contains a linear polyester-based polymer and a non-linear polyester-based polymer. It has been found that using a combination of a linear polyester-based polymer, substantially free of gel with some specific melt properties, in combination with a non-linear polyester-based polymer, containing an intermediate amount of gel and a melt behaviour tuned to the melt behaviour of the linear polyester-based polymer, and using said combination of polymers in some specific weight ratio, an excellent fixing performance can be obtained at moderate temperatures.

By the term “non-linear”, is meant that the amount of cross-linking agent present in the polymeric structure is less than 1% expressed in molar ratio to either alcohol and/or acid depending on the specific type of cross-linker used. The presence of both a linear and a non-linear polyester-based polymer is essential. It has been observed that using such a combination, even with melt behaviour within the specified ranges, but with the non-linear polyester-based polymer having no gel content or a gel content lower than 3%, it is not possible to realise the fixing performance. Whereas some melt viscosity range is needed in order to meet in general the requirement of the fixing degree of the copy, it was found that this range can be rather broad, as long as a specific relation of melt behaviour of the non-linear to the linear polyester-based polymer is met. Also it was found that an appreciable amount of both polyester-based polymers should be present

The melt behaviour of the first polyester-based polymer should lay in a region between 50 and 1000 Pa s at 120° C., and showing a low elastic behaviour. The gel content should be below 3% by weight, preferably below 1%, and ideally no gel should be present. It has been found by experiment that the presence of the linear polyester-based polymer is essential.

The second polyester-based polymer has to be a non-linear polyester-based polymer. This means that the amount of cross-linker has to be larger than 1%, and even such that an appreciable amount of gel is present. The amount of gel should be in the region of 3-30% by weight, preferably in the region of 5 to 15%. Although in prior art the amount of gel is often at higher levels, this seems not to give the desired performance. Also the presence of gel is essential, as was found surprisingly by the experimental observation that a viscoelastic, almost identical, cross-linked polyester-based polymer but without gel, did not give good performance.

Without wishing to be bound by theory, it is believed that the specific interaction of linear and non linear polyester-based polymer chains with intermixed gel-domains gives the fixing performance resulting in said good fixing quality, good gloss level, and gloss evenness, allowing for fixing at fair speed and with minimal release agent consumption.

Polyester-based polymer resin compositions suited for the present invention can have a variety of compositions, as the composition itself is not believed to be essential in the invention. The polyester-based polymer is defined as having a polyester-based polymer content of at least 60% by weight. Linear polyester-based polymers suitable for use in toner particles according to the present invention can be selected e.g. from the group of polycondensation products of (i) di-functional organic acids, e.g. maleic acid, fumaric acid, succinic acid, adipic acid, terephthalic acid, isophthalic acid, with (ii) di-functional alcohols (diols) such as ethylene glycol, triethylene glycol, an aromatic dihydroxy compound, preferably a bisphenol such as 2,2-bis (4-hydroxyphenyl)-propane called bisphenol A, or an alkoxylated bisphenol, e.g. propoxylated bisphenol A, examples of which are given in U.S. Pat. No. 4,331,755.

Examples of suitable non-linear resins are disclosed in British patent GB 1373220. Furthermore, a non-linear gel-containing resin suitable for use in toner particles according to the present invention can be selected e.g. from the group of resins obtained from similar compositions as mentioned above for the linear polyester-based polymers but containing additionally at least 1%, expressed in molar ratio, of a tri- or higher valent monomer. If an acidic cross-linker is used, this can be selected e.g. from the group of aromatic poly-acids with valence higher than 2, such as e.g. trimellitic acid. If an alcohol-based cross-linker is used, this can be selected e.g. from the group of 2-ethyl-2-hydroxymethyl-1,3-propanediol, tetrakishydroxymethylmethane, glycerol, be used.

Examples of particularly useful polyester resins are listed in the following Table 1, mentioning melt viscosity and elasticity at 120° C., gel content, composition and type of polyester:

TABLE 1

| | | Vis- | | | | |
|---|---|---|---|---|---|---|
| Resin | Gel | cosity | | | | |
| num- | content | 120° C. | Elasticity | | Alcohol | Acid |
| ber | % | [Pa s] | 120° C. [] | Type | monomers | monomers |
| 1 | 11 | 430 | 0.43 | Non- | EBA/PBA | IA + |
| | | | | linear | (50/50) | TA/TMA |
| | | | | | | (60/40) |
| 2 | 0 | 400 | 0.2 | Linear | EBA/EG | IA/TA |
| | | | | | (80/20) | (40/60) |
| 3 | 0 | 80 | 0.03 | Linear | PBA (100) | TA/AA |
| | | | | | | (75/25) |
| 4 | 0 | 470 | 0.45 | Non- | EBA/PBA | IA + TA/T |
| | | | | linear | (50/50) | MA |
| | | | | | | (60/40) |

The resin compositions are mentioned in Table 1 using following abbreviations:
EBA ethoxylated bisphenol A
PBA propoxylated bisphenol A
IA Isophthalic acid
TA Terephthalic acid
TMA Trimellitic acid
EG Ethylene glycol
AA Adipic acid

Test for the Determination of Gel Content

The gel content is obtained by putting 0.5 g of the resin (r) into 50 ml of tetrahydrofuran (THF), dissolving with heat at 60° C. for 3 hours, filtering the obtained insoluble resin composition over a filter of 0.5 μm pore size, and drying at 80° C. in a vacuum. The weight % of the insoluble component, i.e. the gel content can be calculated by the formula:

gᵣ(%)=(W_{d}/0.5)*100

where W_{d} means the weight (in grammes) of the dried insoluble component.

Test for the Determination of Viscosity and Elasticity of the Resin

For determining the melt viscosity of the selected sample a CARRIMED CSL500 is used. The viscosity measurement is carried out at a sample temperature of 120° C. The sample having a weight of 0.75 g is applied in the measuring gap (about 1.5 mm) between two parallel plates of 20 mm diameter one of which is oscillating about its vertical axis at 100 rad/sec and amplitude of 5×10⁻³ radians. Before recording, the sample is allowed to attain thermal equilibrium for 10 minutes.

The viscosity is expressed in Pa s and elasticity is defined by the following formula:

Elasticity=(tg δ)⁻¹

where δ is the loss angle (see “Styrene-Acrylate Copolymers as Toner Resins: Correlations Between Molecular Structure, Viscoelastic Behavior, and Fusing Properties” by Forgo and Ragnetti and Stübbe, Journal of Imaging Science and Technology, Volume 37, Number 2, March/April 1993).

For producing visible images the toner powder contains in the resinous binder a colorant which may be black or having a colour of the visible spectrum, not excluding however the presence of mixtures of colorants to produce black or a particular colour.

In black-and-white reproduction, the colorant is usually an inorganic pigment which is preferably carbon black, but can be likewise e.g. black iron (III) oxide. Inorganic coloured pigments are e.g. copper (II) oxide and chromium (III) oxide powder, milori blue, ultramarine cobalt blue and barium permanganate.

Examples of carbon black are lamp black, channel black and furnace black e.g. SPEZIALSCHWARZ IV (trade name of Degussa Frankfurt/M—Germany) and VULCAN XC72 and CABOT REGAL 400 (trade names of Cabot Corp. High Street 125, Boston, U.S.A.). Some further characteristics of the pigments are disclosed in U.S. Pat. No. 5,569,567 (Xeikon) which is hereby incorporated completely by reference.

In order to obtain toner particles having magnetic properties, a magnetic or magnetizable material in finely divided state is added during the toner production.

Materials suitable for said use are e.g. magnetizable metals including iron, cobalt, nickel and various magnetizable oxides, e.g. haematite (Fe₂O₃), magnetite (Fe₃O₄), CrO₂ and magnetic ferrites, e.g. these derived from zinc, cadmium, barium and manganese. Likewise various magnetic alloys may be used, e.g. permalloys and alloys of cobalt-phosphors, cobalt-nickel and the like or mixtures of these.

In the preparation of coloured toner particles a resin blend as defined herein is mixed with said colouring matter which may be dispersed in said blend or dissolved therein forming a solid solution. The colorants may be dyes soluble in the binder resin or pigments including mixtures thereof. Particularly useful organic colorants are selected from the group consisting of phthalocyanine dyes, quinacridone dyes, triaryl methane dyes, sulphur dyes, acridine dyes, azo dyes and fluoresceine dyes. An overview of useful dyes/colorants are also disclosed in U.S. Pat. No. 5,569,567 (Xeikon).

In order to obtain toner particles with sufficient optical density in the spectral absorption region of the colorant, the colorant is preferably present therein in an amount of at least 1% by weight with respect to the total toner composition, more preferably in an amount of 1 to 10% by weight.

Other fillers can be added to the toner composition to fine tune melt properties, for example, colloidal inorganic fillers in such as colloidal silica, alumina and/or titanium dioxide in minor amounts. However care should be taken as inorganic fillers may give rise to an undesired high melt viscosity, the need for higher fusing energies and may inhibit colour brightness.

In order to modify or improve the triboelectric chargeability in either negative or positive direction the toner particles may be composed of specific copolymers, such as e.g. disclosed in U.S. Pat. No. 4,455,360 (Ishikawa et al./Mitsui Toatsu Chemicals, Incorporated) or may contain (a) charge control agent(s). Such charge control agents may be contained in the binder resin in an amount up to 5% by weight. Examples of some negative charge control agents include azo dyes containing metals such as e.g. BONTRON S31 (manufactured by Orient Chemical Co.). Examples of some positive charge control agents include nigrosine dyes such as e.g. BONTRON NO4 (manufactured by Orient Chemical Co.). A charge control agent suitable for use in colourless or coloured toner particles is zinc benzoate and reference therefor is made to European patent application EP 0463876. In addition to or instead of charge control agents, charge levelling agents may be used as e.g. described in U.S. Pat. No. 5,569,567 and U.S. Pat. No. 5,532,097 (both assigned to Xeikon) which are hereby incorporated by reference.

In order to improve the flowability of the toner particles spacing particles may be incorporated therein. Said spacing particles are embedded in the surface of the toner particles or protruding therefrom. These flow improving additives are preferably extremely finely divided inorganic or organic materials the primary (i.e. non-clustered) particle size of which is less than 50 nm. Widely used in this context are fumed inorganics of the metal oxide class, e.g. selected from the group consisting of silica (SiO₂), alumina (Al₂O₃), zirconium oxide and titanium dioxide or mixed oxides thereof which have a hydrophilic or hydrophobized surface.

Fumed metal oxides are prepared by high-temperature hydrolysis of the corresponding vaporizable chlorides. The fumed metal oxide particles have a smooth, substantially spherical surface and before being incorporated in the toner mass are preferably coated with a hydrophobic layer, e.g. formed by alkylation or by treatment with organic fluorine compounds. Their specific surface area is preferably in the range of 40 to 400 m²/g.

In preferred embodiments the proportion of fumed metal oxides such as silica (SiO₂) and alumina (Al₂O₃) incorporated in the particle composition of the toner particles is in the range of 0.1 to 10% by weight.

Fumed silica particles are commercially available under the tradenames AEROSIL and CAB-O-Sil being trade names of Degussa, Frankfurt/M Germany and Cabot Corp. Oxides Division, Boston, Mass., U.S.A. respectively. For example, AEROSIL R972 (tradename) can be used which is a fumed hydrophobic silica having a specific surface area of 110 m²/g.

In addition to the fumed metal oxide, a metal soap e.g. zinc stearate may be present in the toner particle composition.

The toner particles according to the present invention are prepared by mixing the above defined binder and ingredients in the melt phase, e.g. using a kneader. The kneaded mass preferably has a temperature in the range of 90 to 140° C., and more preferably in the range of 105 to 120° C. After cooling the solidified mass is crushed, e.g. in a hammer mill and the obtained coarse particles further broken e.g. by a jet mill to obtain sufficiently small particles from which a desired fraction can be separated by sieving, wind sifting, cyclone separation or other classifying technique. The actually used toner particles have preferably an average diameter between 3 and 20 μm determined versus their average volume, more preferably between 5 and 10 μm when measured with a COULTER COUNTER (registered trade mark) Model TA II particle size analyzer operating according to the principles of electrolyte displacement in a narrow aperture and marketed by COULTER ELECTRONICS Corp. Northwell Drive, Luton, Bedfordshire, LC33, UK. In said apparatus particles suspended in an electrolyte (e.g. aqueous sodium chloride) are forced through a small aperture, across which an electric current path has been established. The particles passing one-by-one each displace electrolyte in the aperture producing a pulse indicative of the displaced volume of electrolyte. Thus particle volume response is the basis for said measurement. The average diameter (size) of the toner particles derived from their average volume or weight is given by the instrument (see also ASTM Designation: F 577-83).

Suitable milling and air classification may be obtained when employing a combination apparatus such as the Alpine Fliessbeth-Gegenstrahlmühle (A.G.F.) type 100 as milling means and the Alpine Turboplex Windsichter (A.T.P.) type 50 G.C. as air classification means, available from Alpine Process Technology, Ltd., Rivington Road, Whitehouse, Industrial Estate, Runcorn, Cheshire, UK. Another useful apparatus for said purpose is the Alpine Multiplex Zick-Zack Sichter also available from the last mentioned company.

To the obtained toner mass a flow improving agent is added in a high speed stirrer, e.g. HENSCHEL FM4 of Thyssen Henschel, 3500 Kassel Germany.

In the preferred toner composition according to the invention, the linear polyester-based polymer (a) is characterised by an elasticity (tg δₐ)⁻¹ (as measured at 120° C.) less than 0.25. The melt viscosity ηₐ for the polymer (a) is preferably less than the melt viscosity η_{b} for the polymer (b). It is also preferred that the weight ratio of the total amount of linear resin (a) and non-linear resin (b) to the binder resin is larger than 2:3. ηₐ is preferably between 50 and 500 Pa s, and η_{b} is between 250 and 750 Pa s., while the final viscosity of the resultant toner, η_{t,} is preferably between 150 and 750 Pa s, most preferably between 250 and 600 Pa s. The elasticity (tg δₜ)⁻¹ of the final toner is preferably larger than 0.25 but smaller than 0.75, most preferably larger than 0.35 but smaller than 0.55.

The toner particles according to the present invention may be used as mono-component developer, i.e. in the absence of carrier particles, but are preferably used in a two-component system comprising carrier particles. When used in admixture with carrier particles, 2 to 10% by weight of toner particles may be present in the whole developer composition. Proper mixing with the carrier particles may be obtained in a tumble mixer. For magnetic brush development the carrier particles may be on the basis of ferromagnetic material e.g. steel, nickel, iron beads, ferrite and the like or mixtures thereof. The ferromagnetic particles may be coated with a resinous envelope or are present in a resin binder mass. The average particle size of the carrier particles is preferably in the range of 20 to 300 μm and more preferably in the range of 30 to 100 μm. Reference is also made to specific carrier particles as described in European patent application EP 0656130 and European patent application EP 0898206, both assigned to Xeikon and incorporated by reference.

The toner composition according to the present invention is suited for the fixing of (multi-)colour images in general, but is particularly advantageous when executing contact fusing at moderate temperatures, i.e. between 140 and 210 degrees Centigrade, using a specific fuser unit. The fuser unit comprises a heated upper roller as a fuser roller and a heated backing roller as backing member. A substrate carrying non-fixed toner images is conveyed through the nip formed by establishing pressure contact between the heated upper and lower roller. The substrate may carry unfixed toner images on one side (simplex) or both sides (duplex). The unfixed toner images preferably have a residence time in the contact zone in the range from 50 ms to 250 ms. During fixing a limited amount of release agent is applied on the outermost surface of the heated roller for contacting the unfixed toner images at a rate corresponding with an amount of not more than 20 mg per surface area of a substrate, said surface area being equivalent to one side of an A4 page. In the case of duplex printing, the configuration according to the present invention avoids that a release agent is applied twice to the same side of a print since only one pass is used, instead of the two passes in conventional fixing units. In producing halftone, i.e. screened images, toner-contacting pressure fuser rollers can distort the dot structure of the screened images. Such will be particularly the case when the pressure-fuser roller does not have a perfectly smooth structure and texturizes the obtained image. Also it is observed to be advantageous that the fuser roller has a micro-conformability property so as to avoid too big a difference in pressure on the micro-scale arising from differences in pile-height of the toner images, or from small non-uniformities in the network density of the rollers. Such pressure differences on the micro-scale distort the image by the fact that patch-like gloss or texture differences appear in the image, which image defect is commonly called ‘leopard skin’. The micro-conformability ensures uniformity of the pressure and avoids this defect.

Preferably, at least one of the upper and lower rollers is composed of a rigid core covered with a conformable silicone rubber based layer, most preferably at least one of the upper and lower rollers is composed of multiple layers and have an outermost layer formed of a material comprising dimethylsiloxane units. Ideally, the heated upper and lower rollers are independently driven and, during the fixing, the heated upper and lower rollers at least in the contact zone are heated to a temperature from 120° C. to 190° C.

In a preferred embodiment of the invention a symmetrical fusing unit is used having a quasi-identical upper and lower rollers. Such a configuration is particularly advantageous with respect to duplex prints. This means that both rollers have similar hardness, and conformability and therefore define the fixing nip in a symmetrical way. The print to be fused passes in one single pass through said nip, allowing the fixing of toner images on both sides of the final substrate in said one single pass. This layout avoids the difference in fixing quality of double sided colour images, which are fixed in two separate passes through a fixing unit, as is common in colour printers using contact fusing.

It has also been found by experiment that the use of the toner of the invention with the described fixing unit allows the fusing of a sandwich of two single sheets, each of them carrying toner images on a single side, being the side contacting the heated upper and lower roller respectively, upon passing in a back-to-back relationship through said fixing unit. A good fixing performance for both images was observed. This procedure enables one to increase the throughput of printing engines in simplex mode by combining unfused prints as described above. It has been observed that prints on a paper substrate up to 120 g/m² could be fixed in this way.

In an exemplary embodiment of the present invention, a symmetrical fixing unit is used containing two quasi-identical fuser rollers, being a heated upper roller and a heated lower roller. The outer diameter of the rollers is 73 mm. Both rollers are silicone rubber based, and have a hardness of 50 Shore A, and have a thickness of the rubber coating of 3 mm. Thermal conductivity is set at 0.4 W/mK. Electrical conductivity is set at medium level in order to avoid paper jams due to electrification. Said rollers allow the formation of a nip of 9-10 mm at a linear pressure so that no permanent deformation occurs. Both rollers were oiled at a rate corresponding to a low oil deposition on the fixed print. The oil deposition is defined as the amount of oil deposited on a single side of a A4 size paper upon the fixing process in a multiple print mode and expressed in mg/A4. It has been found that oil defects are drastically decreasing when this oil deposition is set lower than 30 mg/A4. In the preferred embodiment the oiling rate is set at 10-15 mg/A4. It was found that using the toner composition of the invention no hot-offset problems were found using said low oiling rate, even at levels down to 7 mg/A4. It was hence found that oil induced image defects could be avoided. It was furthermore found that the fixing degree on different substrates was good, even for heavy paper substrate up to 450 g/m² and up to fixing speeds of 12 cm/s. In the preferred embodiment the fixing speed is set at 9 cm/s, corresponding to a dwell time of 100 msec for a nip of 10 mm. The temperature of the fixing device typically is set in the range of 120-180° C., depending on the thickness of the substrate, as thicker substrates need more energy to be fixed. Typically a 100 g/m² paper is fused at 155° C. It was furthermore found that a preferred situation with regard to stability in oiling was obtained when an uppermost dimethylsiloxane containing coating was present on both rollers. It is believed that the correspondence in chemical nature between the release agent and the top layer stabilises the oiling rate, which is important when low oiling rates are used.

Reference Fixing Test for Toner Evaluation

Fixing is done with the unit as described in the preferred embodiment. The images were put on uncoated paper of 100 g/m². The temperature of the fixing device was set at 155° C. With the different toners unfused images were made with a deposited toner mass of 0.5 mg/cm² and 1 mg/cm². The unfused toner images were fused on a stand-alone fusing unit corresponding to the preferred embodiment.

On the fixed toner images gloss measurements were performed at a reflection angle of 60 according to DIN standard No. 67 530 (November 1972).

The fusing towards gloss was evaluated in terms of gloss level and gloss difference.

Gloss level: absolute gloss level at 155° C. for deposited toner mass of 1 mg/cm², with ratings:

1: excellent

2: acceptable

3: too low

4: too high

Gloss difference: gloss difference between a deposited toner mass of 1 mg/cm² and 0.5 mg/cm² at a fusing temperature of 155° C. with ratings:

1: excellent

2: acceptable

3: bad

4: very bad

The present invention without limiting it thereto is illustrated by the following Examples. All ratios, percentages and parts mentioned therein are by weight unless stated otherwise.

### EXAMPLES

Preparation of Example Toner 1

48.5 parts of resin No. 1 and 48.5 parts of resin No. 2 of Table 1 were melt-blended for 30 minutes at 110° C. in a laboratory kneader with 3 parts of Cu-phthalocyanine pigment (Colour Index PB 15:3).

After cooling the solidified mass was pulverized and milled using an ALPINE Fliessbettgegenstrahlmühle type 100AFG (tradename) and further classified using an ALPINE multiplex zig zag classifier type 100MZR (tradename). The average particle diameter of the separated toner was measured by Coulter Counter model Multisizer (tradename) was found to be 8.3 μm by volume. In order to improve the flowability of the toner mass the toner particles were mixed with 0.5% of hydrophobia colloidal silica particles (BET-value 130 m²/g).

Preparation of Example Toner 2

34 parts of resin No. 1 and 63 parts of resin No. 2 of Table 1 were melt-blended for 30 minutes at 110° C. in a laboratory kneader with 3 parts of Cu-phthalocyanine pigment (Colour Index PB 15:3).

After cooling the solidified mass was pulverized and milled using an ALPINE Fliessbettgegenstrahlmühle type 100AFG (tradename) and further classified using an ALPINE multiplex zigzag classifier type 100MZR (tradename). The average particle diameter of the separated toner was measured by Coulter Counter model Multisizer (tradename) was found to be 8.4 μm by volume. In order to improve the flowability of the toner mass the toner particles were mixed with 0.5% of hydrophobic colloidal silica particles (BET-value 130 m²/s).

Preparation of Example Toner 3

63 parts of resin No. 1 and 34 parts of resin No. 3 of Table 1 were melt-blended for 30 minutes at 110° C. in a laboratory kneader with 3 parts of Cu-phthalocyanine pigment (Colour Index PB 15:3).

After cooling the solidified mass was pulverized and milled using an ALPINE Fliessbettgegenstrahlmühle type 100AFG (tradename) and further classified using an ALPINE multiplex zigzag classifier type 10OMZR (tradename). The average particle diameter of the separated toner was measured by Coulter Counter model Multisizer (tradename) was found to be 8.35 μm by volume. In order to improve the flowability of the toner mass the toner particles were mixed with 0.5% of hydrophobic colloidal silica particles (BET-value 130 m²/g).

Preparation of Comparative Example Toner 1

63 parts of resin No. 4 and 34 parts of resin No. 3 of Table 1 were melt-blended for 30 minutes at 110° C. in a laboratory kneader with 3 parts of Cu-phthalocyanine pigment (Colour Index PB 15:3).

After cooling the solidified mass was pulverized and milled using an ALPINE Fliessbettgegenstrahlmühle type 100AFG (tradename) and further classified using an ALPINE multiplex zigzag classifier type 10OMZR (tradename). The average particle diameter of the separated toner was measured by Coulter Counter model Multisizer (tradename) was found to be 8.35 μm by volume. In order to improve the flowability of the toner mass the toner particles were mixed with 0.5% of hydrophobic colloidal silica particles (BET-value 130 m²/g).

Preparation of Comparative Example Toner 2

48.5 parts of resin No. 2 and 48.5 parts of resin No. 3 of Table 1 were melt-blended for 30 minutes at 110° C. in a laboratory kneader with 3 parts of Cu-phthalocyanine pigment (Colour Index PB 15:3).

After cooling the solidified mass was pulverized and milled using an ALPINE Fliessbettgegenstrahlmühle type 100AFG (tradename) and further classified using an ALPINE multiplex zigzag classifier type 10OMZR (tradename). The average particle diameter of the separated toner was measured by Coulter Counter model Multisizer (tradename) was found to be 8.25 μm by volume. In order to improve the flowability of the toner mass the toner particles were mixed with 0.5% of hydrophobic colloidal silica particles (BET-value 130 m²/g).

Preparation of Comparative Example Toner 3

97 parts of resin No. 1 of Table 1 was melt-blended for 30 minutes at 110° C. in a laboratory kneader with 3 parts of Cu-phthalocyanine pigment (Colour Index PB 15:3).

After cooling the solidified mass was pulverized and milled using an ALPINE Fiessbettgegenstrahlmühle type 100AFG (tradename) and further classified using an ALPINE multiplex zigzag classifier type 10OMZR (tradename). The average particle diameter of the separated toner was measured by Coulter Counter model Multisizer (tradename) was found to be 8.35 μm by volume. In order to improve the flowability of the toner mass the toner particles were mixed with 0.5% of hydrophobic colloidal silica particles (BET-value 130 m²/g).

Preparation of comparative example toner 4

92 parts of resin No. 1 and 5 parts of resin No. 3 of Table 1 were melt-blended for 30 minutes at 110° C. in a laboratory kneader with 3 parts of Cu-phthalocyanine pigment (Colour Index PB 15:3).

After cooling the solidified mass was pulverized and milled using an ALPINE Fiessbettgegenstrahlmühle type 100AFG (tradename) and further classified using an ALPINE multiplex zigzag classifier type 100MZR (tradename). The average particle diameter of the separated toner was measured by Coulter Counter model Multisizer (tradename) was found to be 8.35 μm by volume. In order to improve the flowability of the toner mass the toner particles were mixed with 0.5% of hydrophobic colloidal silca particles (BET-value 130 m²/g).

Each of the above prepared example toners 1, 2 and 3 and comparative examples toners 1, 2, 3 and 4 were used to form a 2 component developer by mixing said toner particles with silicone-coated Cu—Zn ferrite carrier particles having an average diameter of 50 μm in a 5% ratio. The fixing test as described above was done and results are given in Table 4 where viscosity and elasticity is determined at 120 degrees Centigrade.

TABLE 4

| | | | Non- | % Non | Visco | Elas | | |
|---|---|---|---|---|---|---|---|---|
| | Linear | % linear | linear | linear | toner | toner | Gloss | Gloss |
| | resin a | resin a | resin b | resin b | [Pa s] | [] | level | difference |
| Toner | | | | | | | | |
| example no. | | | | | | | | |
| 1 | 2 | 48.5 | 1 | 48.5 | 400 | 0.38 | 1 | 2 |
| 2 | 2 | 63 | 1 | 34 | 330 | 0.3 | 2 | 2 |
| 3 | 3 | 34 | 1 | 63 | 330 | 0.43 | 1 | 1 |
| Comparative | | | | | | | | |
| example no. | | | | | | | | |
| 1 | 3 | 34 | 4 | 63 | 310 | 0.41 | 2 | 3 |
| 2 | 2 | 48.5 | 3 | 48.5 | 300 | 0.2 | 4 | 4 |
| 3 | — | — | 1 | 97 | 440 | 0.45 | 3 | 3 |
| 4 | 3 | 5 | 1 | 94 | 400 | 0.44 | 2 | 3 |

What is claimed is:

1. A toner composition comprising a colorant and a binder resin, said binder resin comprising a linear polyester-based polymer (a) and a non-linear polyester-based polymer (b), said linear polyester-based polymer (a) being characterised by a gel content gₐ of less than 3% by weight, and a melt viscosity ηₐ, (as measured at 120° C.) of between 50 and 1000 Pa s, and said non-linear polyester-based polymer (b) being characterised by a gel content g_{b} of between 3 and 30% by weight, a melt viscosity η_{b} (as measured at 120°) of between 100 and 1000 Pa s and an elasticity (tg δ_{b})⁻¹ as measured at 120° C.) of at least 0.25, wherein for said polymers (a) and (b)
(tg δₐ)⁻¹<2/3(tg δ_{b})⁻¹
and the amount of polymer (a) versus polymer (b) is between 1:4 and 4:1 by weight.

2. A toner composition according to claim 1, wherein the gel content gₐ of said linear polymer (a) is less than 1% by weight.

3. A toner composition according to claim 1 or 2, wherein the melt viscosity ηₐ for said polymer (a) is less than the melt viscosity η_{b} for said polymer (b).

4. A toner composition according to any preceding claim, wherein said linear polyester-based polymer (a) is characterised by an elasticity (tg δₐ)⁻¹ (as measured at 120° C.) less than 0.25.

5. A toner composition according to any preceding Claim, wherein said non-linear polymer (b) is characterised by a gel content g_{b} of between 5 and 15% by weight.

6. A toner composition according to any preceding claim, wherein the weight ratio of the total amount of linear polyester-based polymer (a) and non-linear polyester-based polymer (b) to the binder resin is larger than 2:3.

7. A toner composition according to any preceding claim, wherein ηₐ is between 50 and 500 Pa s, and η_{b} is between 250 and 750 Pa s.

8. A toner composition according to any preceding claim, wherein the amount of said linear polyester-based polymer (a) versus said non-linear polyester-based polymer (b) is between 1:3 to 3:1.

9. A toner composition according to any preceding claim, where the final viscosity of the resultant toner, η_{t,} is between 150 and 750 Pa s and the elasticity (tg δₜ)⁻¹ of the final toner is larger than 0.25 but smaller than 0.75.

10. A method for fixing unfixed toner images on a recording medium comprising:
feeding at least one recording medium carrying unfixed toner images on at least one surface to a fusing station, said unfixed toner images being composed of toner particles according to any of the preceding claims; and
fixing said unfixed toner images on said recording medium by passing said recording medium through a contact zone in said fusing station, formed by pressing a heated upper roller against a heated lower roller in said fusing station.

11. A method according to claim 10, wherein said unfixed toner images have a residence time in said contact zone in the range from 50 ms to 250 ms.

12. A method according to claim 10 or 11, wherein, in said step of fixing said unfixed images, a release agent is applied on the outermost surface of at least one of said heated upper and lower rollers at a rate corresponding with an amount of not more than 20 mg per surface area of said recording medium, said surface area being equivalent to one side of an A4 page.

13. A method according to claim 10 or 11, wherein said recording medium carries unfixed toner images on both surfaces thereof and, in said step of fixing said unfixed images, a release agent is applied on the outermost surface of both said heated upper and lower rollers at a rate corresponding with an amount of not more than than 20 mg per surface area of said recording medium, said surface area being equivalent to one side of an A4 page.

14. A method according to any of the claims 10 to 13, wherein at least one of said upper and lower rollers is composed of a rigid core covered with a conformable silicone rubber based layer.

15. A method according to any of the claims 10 to 14, wherein at least one of said upper and lower rollers is composed of multiple layers and have an outermost layer formed of a material comprising dimethylsiloxane units.

16. A method according to any of the claims 10 to 15, wherein said upper and lower rollers are both composed of a rigid core covered with a conformable silicone rubber based layer and said upper and lower rollers are both composed of multiple layers and have an outermost layer formed of a material comprising dimethylsiloxane units.

17. A method according to any of the claims 10 to 16, wherein said heated upper and lower rollers are independently driven.

18. A method according to any of the claims 10 to 17, wherein during said fixing said heated upper and lower rollers at least in said contact zone are heated to a temperature from 120° C. to 190° C.
